(19) United States
(12) Patent Application Publication
(10) Pub. No.: US 2006/0107562 A1
(43) Pub. Date: May 25, 2006

(54) Bottle advertising carrier and method of using same

(76) Inventor: Roger D. Buck, Pittsburg, KS (US)

Correspondence Address: WARD KRAFT, INC., P.O. BOX 938, FORT SCOTT, KS, 66701, US

(21) Appl. No.: 10/993,188

(22) Filed: Nov. 19, 2004

(51) Int. Cl. G09F 3/00

(52) U.S. Cl. 40/310

(57) ABSTRACT

The present invention relates to a communication device or promotional item, in which an elongated advertising messaging substrate may be manipulated into a circular formation suitable for displaying an advertising message about a cylindrical portion of an article. An exemplary use of this product includes a decorative piece, sales tag or advertisement article in grocery stores, retail stores, wholesale stores, franchise operations, merchandising outlets, welcoming or greeting memorandums, redemption pieces and/or coupons. The messaging substrate may be used as a notice and/or memo in parties, ceremonies, graduations, weddings, anniversaries, promotions, competitive wins, political victories, promotional and/or advertising campaign articles and as religious or scriptural publications.

### CROSS-REFERENCES TO RELATED APPLICATIONS

None.

### FIELD OF THE INVENTION

The present invention relates to marketing collateral that is suitable for use with advertising products and services or commemorating a particular event. The marketing collateral of the instant application is a communication messaging device, advertising device or promotional product that is constructed from a sheet or substrate to be used for marketing purposes in retail, wholesale, franchise operations, or for commemorative situations such as personal and/or home use, parties, ceremonies, graduations, vendor, and entrepreneur occasions and/or events. The construction of the present invention may also be used to provide coupons, redemption articles, greetings and welcome memorandums, and the like.

### BACKGROUND OF THE INVENTION

There are a number of printed communication pieces, which are used to attract the attention of potential consumers. In today's society, grabbing the focus of passersby becomes all the more important as there is only a finite amount of time by which a presenter of products and services can attempt to impact his or her business through gaining new customers, or “up-selling” additional products and services to existing customers.

Examples of such prior marketing communications pieces include placemats, table and shelf talkers, flyers, placards, labels and the like. Still other pieces include utensil wraps that are also generally constructed from paper and may be provided with or without slits. If slits are not used, then the construction may include adhesive such that when the paper product is shaped into a circular formation the adhesive on both ends of the paper product hold the product in its circular shape. Some utensil wraps have been created with permanent adhesive that creates a strong bond so that the paper product has to be torn to be removed from utensil or other physical apparatuses. Today, many wrap constructions are designed with repositionable adhesives for the easy use of separating the joined ends of the paper product.

While these prior art constructions have been effective in reaching the intended audience, unfortunately, in an effort to have a greater impact on the potential consumer, it would behoove the marketer of products and services to have a further vehicle by which to deliver a message and one which would add some level of creativity to the presentation.

As such, what is needed therefore is another marketing vehicle which can be tailored to further accentuate a particular product or service offering or prepared for a commemorative event in order to attract the attention of the consumer or passerby.

### BRIEF SUMMARY OF THE INVENTION

The embodiments of the present invention described below are not intended to be exhaustive or to limit the invention to the precise paper product ad concept disclosed in the following detailed description. Rather, the embodiments are chosen and described, so that others skilled in the art may appreciate and understand the principles and practices of the present invention.

The messaging substrate of the present invention relates to a paper sheet that has partial cuts or slits, a pre-printed image and/or pre-printed message such that when the contrivance is positioned or shaped into a formation complimentary to the article to which it is attached by the partial cuts or slits are locked together in such a way so as to create a full image and/or message in order to communicate and/or use the device as a decorative display.

In one exemplary embodiment, an elongated advertising substrate is provided and includes a substrate that has first and second faces, and first and second ends with each of the first and second faces having a surface. The first face of the substrate has a first area defined by an area between a first slit and the first end for receiving indicia relating to a first part of an advertising message and the second face has a second area defined by an area between the second end and a second slit for receiving indicia relating to a second part of an advertising message. One of the first and second parts comprises a substantial portion of the message, that is greater than fifty percent of the message. The slits are generally disposed closer to the ends than to a mid point of the construction.

Still continuing with the presently described embodiment, each of the first and second areas has at least one cut or slit, with the cut of at least one of the areas being approximately adjacent to one of the ends, such that when the substrate is wrapped about an article, the first and second parts of the advertising message cooperate to form a single advertising message.

Another embodiment of the present invention includes an elongated substrate having first and second faces for delivering a marketing message. One face has a first area for receiving partial cuts or slits and the second face has a second area capable of receiving partial cuts or slits.

A further embodiment is provided for the elongated messaging substrate, which includes a substrate that is capable of being manipulated into a circular or other geometric formation. This is accomplished by joining the cut or slit ends of the substrate together and locking them into place so as to be able to removably attach the messaging substrate to a bottle, utensil, vase, flower arrangement and the like. The messaging substrate of the present invention may also be presented with uneven or unequal proportions for forming a pre-printed numerical or pictorial images so as to create a puzzle which is formed when the portions of the substrate are joined to one another. For example, in creating an image of a tower the upper portion of the tower or indicia appears in the majority of the messaging substrate and the base or foundation appears in the lower portion of the substrate, such that by connecting the slits of the substrate, a complete tower or image is produced.

Still a further embodiment of the present invention includes a messaging substrate that has substantially equal portions for aligning a pre-printed numerical or pictorial image, such that when the upper and lower printed indicia is aligned the pre-printed image is formed. A first slit is disposed approximately one forth of the length of the substrate from an edge and the second slit is disposed approximately on half of the length of substrate from the second edge.

### BRIEF DESCRIPTION OF THE DRAWINGS

These, as well as, other objects and advantages of the invention, will be more completely understood and appreciated by referring to the following more detailed description of the presently preferred exemplary embodiments of the invention in conjunction with the accompanying drawings, of which:

FIG. 1 depicts a front view of the messaging substrate and illustrates the series of cuts or slits and exemplary printing for informing, educating, communicating, promotional and/or ad campaign techniques;

FIG. 1A shows the opposite side of the front view wherein additional printing may be viewed;

FIG. 1B illustrates the contrivance with slits interlocked to create a cylindrical formation wherein the printing can be viewed on both sides of the substrate with one of the first and second parts comprising a substantial portion of the printing, that is greater than fifty percent of the message;

FIG. 2 depicts the messaging substrate with printing on one side of the substrate where a first printing is on one end and a second printing is on the other end creating a full and complete message;

FIG. 2A presents the advertising assembly of the present invention with printing on one side of the substrate with first and secondary printing and when formed into a cylindrical shape creates a full and complete message and coupon combination;

FIG. 2B illustrates the contrivance with printing on one side of the substrate with first and secondary printing and when formed into a cylindrical shape creates a full and complete pictorial;

FIG. 2C shows a first, second, and third printing of a message and pictorial combination;

FIGS. 2 through 2C illustrate how the messaging substrate of the present invention may be manipulated and may be viewed before placing on utensils, bottles, vases, flower arrangements and/or other desired apparatuses;

FIGS. 3 and 3A presents a further embodiment of the present invention, as it appears when used as a bottle tag promotional piece or wrapped around an article;

FIG. 3B shows a still further embodiment of the messaging substrate used inn connection with a bundle of flowers; and

FIG. 4 illustrates how the embodiment may be used for home or office decor.

FIG. 5 depicts a marketing block diagram process for the contrivance.

### DETAILED DESCRIPTION OF THE INVENTION

The present invention is now illustrated in greater detail by way of the following detailed description, but it should be understood that the present invention is not to be construed as being limited thereto.

The material that is used for the messaging substrate of the present invention may be selected from any suitable material such as cellulosic-based stock (paper, tag stock, card stock, etc.) or may include all plastic or all synthetic films (polyester, polyethylene, polystyrene based materials) or metalized films and the like.

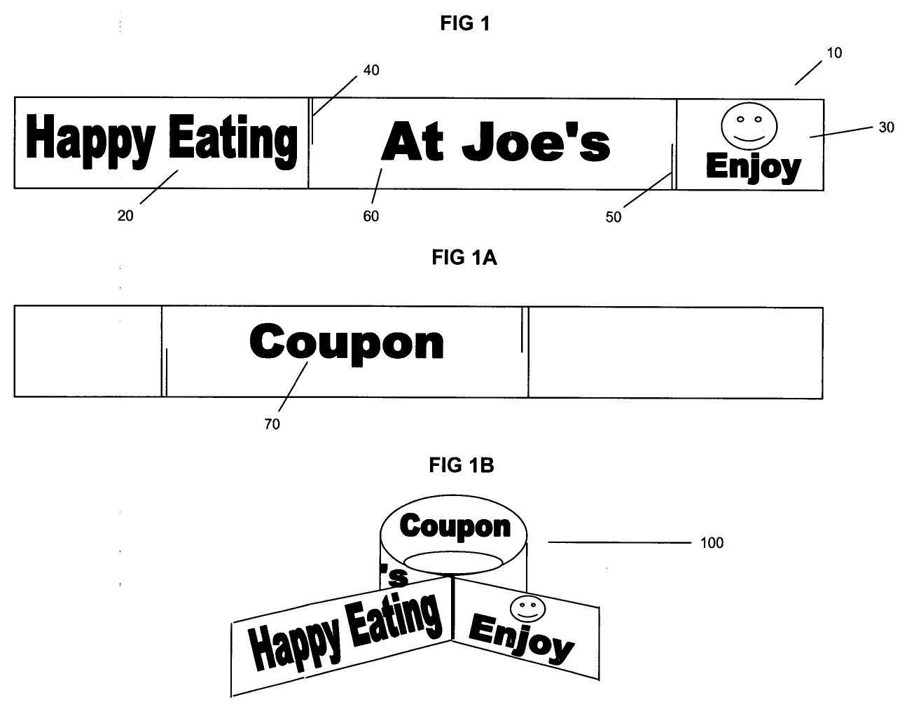

FIG. 1, depicts the messaging substrate which is referenced generally by numeral 10 as seen in this front view. The numerals 20, 30, and 60 refer generally to the front side of the messaging substrate but it should be understood that a second face or opposite side is provided and not shown. Either side of the substrate are suitable for receiving printing, imaging, or other rendering of graphics. Numeral 40 and 50 are slits used for holding the messaging substrate in place once it is manipulated and placed on an article such as a bottle, group of utensils, flower bunch and/or any other desired so called article or item for which it would be useful to include a communication piece.

FIG. 1A, shows the messaging substrate, with a secondary side or opposite side of the front. In the figure, the secondary side or opposite side may contain additional printing. As seen here, numeral 70, depicts the opposite side with printing, and in this case, the opposite side of the contrivance, as being used for a coupon or redemption article.

Turning now to FIG. 1B, numeral 100 depicts the present invention manipulated into a cylindrical shape representing print on both sides of the substrate wherein one of the first and second parts, comprises a substantial portion of the print, that is greater than fifty percent of the message.

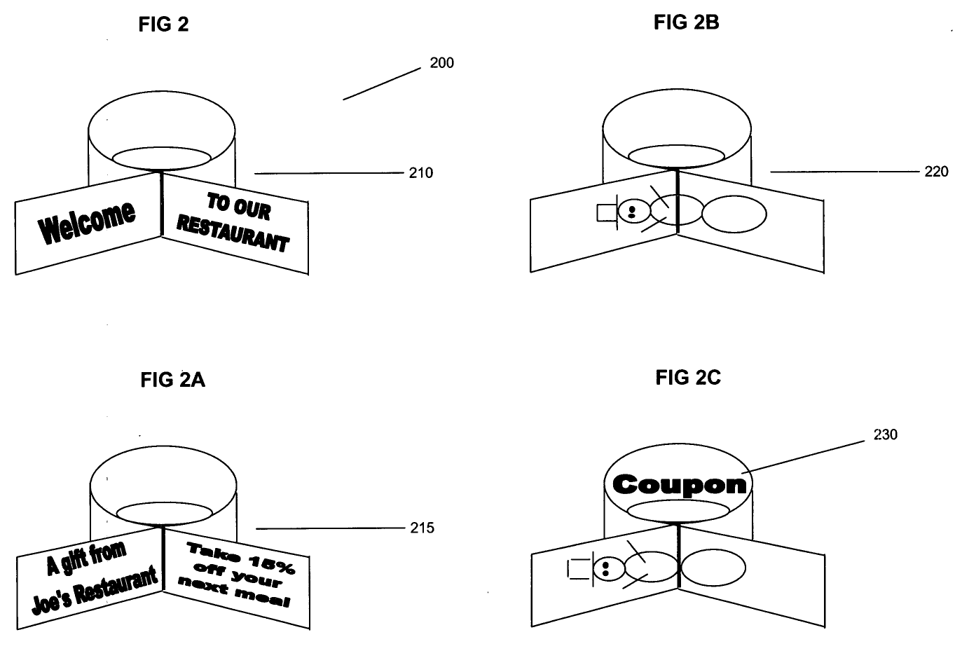

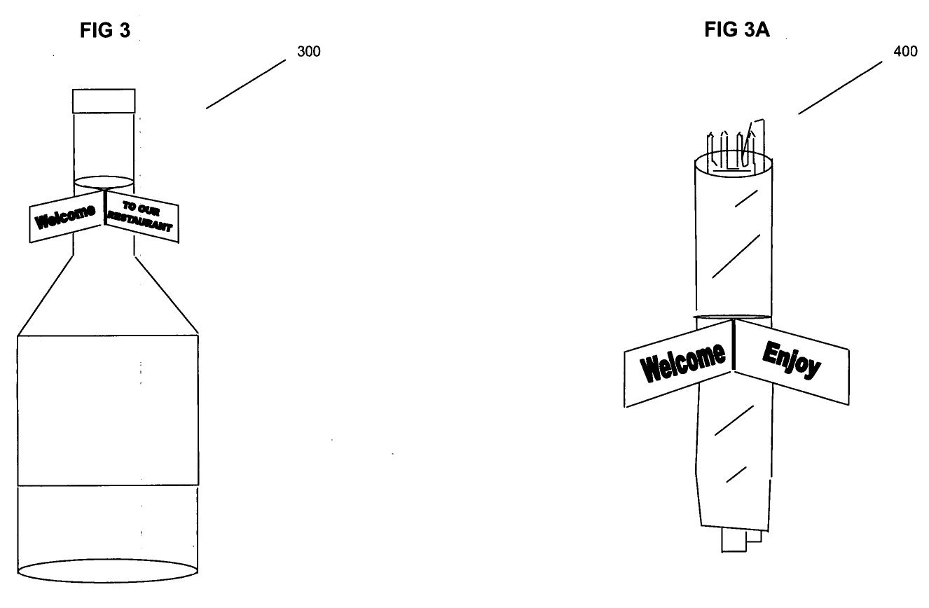

Reference is now directed to FIG. 2, in which numeral 200 refers generally to the messaging substrate of the present invention. In the embodiment shown in FIG. 2 the messaging substrate is manipulated into a geometric configuration (e.g. substantially circular) before placement is made on to a desired item and/or article. Numeral 210 is used to depict the present invention with printed indicia disposed thereon and how such indicia may be used and/or viewed by a consumer.

FIG. 2A, numeral 215 is used to illustrate another exemplary use of the messaging substrate such as for coupons and/or redemption articles. In this example, printed indicia and the manipulation of the substrate around certain articles found in stores may be used for, but not limited to, promoting or marketing specials at café's, restaurants, diners, steak houses, sandwich shops, “greasy spoons,” snack bars, coffee shops, and the like.

In FIG. 2B, numeral 220 provides yet another illustrative embodiment depicting a pictorial or graphical image of the embodiment, wherein the messaging substrate may represent, but is not limited to, any means of pictorials, such as portraits, characters, photo's, comics, pictures, images, and the like.

Referring to FIG. 2C, numeral 230 is used to depict the messaging substrate used as redemption article or coupon, as well as, the display of a pictorial image, reflecting a combination thereof.

In each of the foregoing FIGURES the first and second portions of the substrate are shown with substantially equal portions. However, it has been found preferable to provide a first part of a message on the first part that is substantially larger than the amount of the second part of the message provided on the second part. That is, the first part of the advertising message occupies more than 50% of the available surface of the face whereas the second portion of the message occupies less than 50% of the available surface of the face of the messaging substrate.

In a further embodiment, the first slit extends inwardly about a quarter of the distance of the substrate from the end and the second slit extends inwardly from the second end edge about half the length of the substrate to create a lopsided structure when formed.

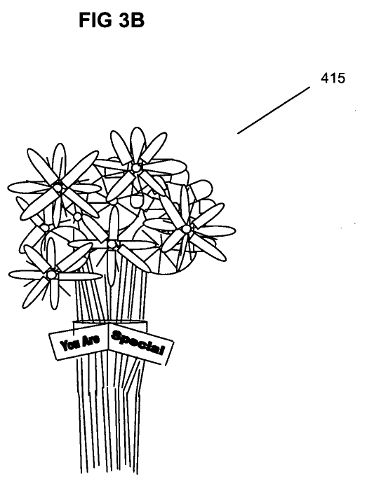

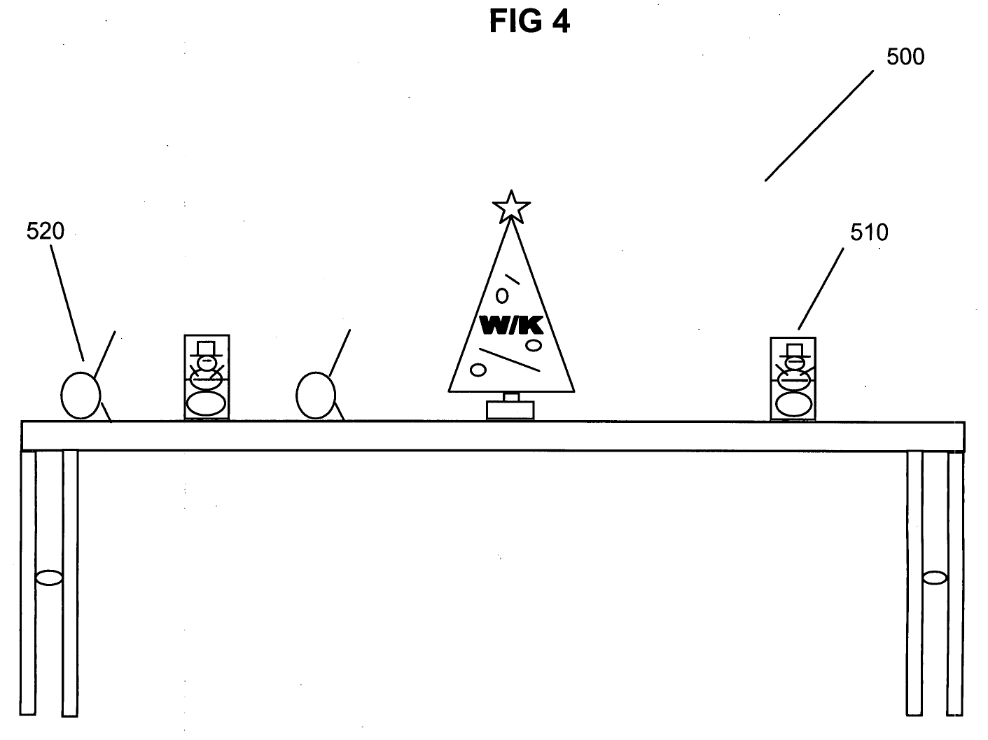

FIG. 3, the messaging substrate is depicted by numeral 300 in which the substrate has been applied to a bottle which may be found in restaurants, grocery stores, retail/wholesale stores and the like. The messaging substrate may be used on a variety of bottles such as wine, soda pop, milk, juice, perfume, cologne, syrup, cooking oils, and any other bottles used for wholesale/retail type applications.

FIG. 3A, depicts numeral 400 as still another embodiment seen here wherein the messaging substrate is applied as a wrap for a group of eating utensils which may be found in homes, restaurants, special lunch/dinner occasions, celebrations, political/electoral occasions, and the like.

FIG. 3B, refers to numeral 415 in which the messaging substrate is used as a flower bundle wrap and may be used to display a special message and/or greeting. The messaging substrate may be used for example for such occasions as Valentines Day, anniversaries, celebrations, funerals, birthdays, Boss's Day, Secretaries Day, religious gatherings, political conventions, and other special or unusual events and/or occasions.

In the examples of FIGS. 3 through 3B the area of the messaging substrate that is in contact with the surface of the article comprises less than about 30% of the length of the substrate such that more area of the substrate is available for producing the advertising message. That is, it will be of little value if the message is concealed or obscured by the article upon which it has been applied.

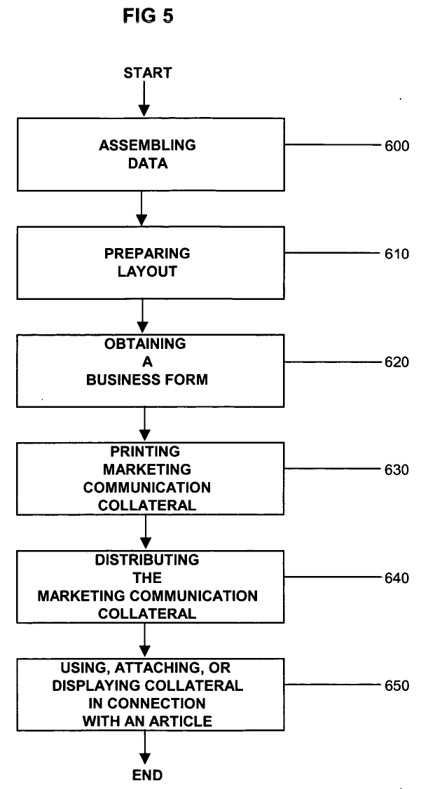

FIG. 4, depicts numeral 500 as a decor setting wherein numeral 510 and 520 represent a means of displaying the invention as a decorative item; numeral 510 showing the front view of the contrivance with a pictorial image and numeral 520 showing the side view depicting the invention in its manipulated state of formation.

FIG. 5, represents a block diagram as an exemplary method of using the present invention. Once started, an assembling of the data takes place as seen in numeral 600.

The next step, numeral 610, includes the preparing of layouts, which may be pictorial, graphical, numerical, or combinations thereof and the like.

The third step of the block diagram, numeral 620, is the obtaining of a business form.

Block numeral 630, depicts printing marketing communication collateral for use in numerous applications in order to communicate a form of messaging.

The next step consists of distributing the marketing communication collateral as seen in numeral 640.

Printing of the substrate may be accomplished by a suitable means such as inkjet, laser printers, digital printing, and the like.

The final step, before the process ends, depicted as numeral 650, is the actual use, of attaching or displaying collateral in connection with an article.

One of the most important things with respect to new product innovations is the need to effectively market and communicate the new product to potential customers and end users of the product. Such marketing typically includes the creation of marketing collateral associated with the features of the marketing substrate of the present invention and then selling the assembly in connection with that marketing collateral and distributing the marketing substrate along with the marketing ideas to potential end users and customers. Customers can include distributors of such products as well as office supply stores, retail and warehouse outlets that may not be end users, but may repackage and resell the products to end users or third parties, and the like.

Still yet a further embodiment of the contrivance is to create a slit or slits in the substrate, wherein at least one slit is found part way through the substrate. The slit or slits are then joined or connected with respect to forming a cylindrical shape, wherein the placement of the contrivance may be placed on articles, such as utensils, bottles, flower arrangements, combinations thereof and the like. The slits are typically created by dies, perf wheels, or perf blades used in traditional rotary press operations

Marketing collateral as used herein includes the use of scripted or prepared material that are distributed through audio and visual communication mediums, over a global communication network, through printed mediums such as newspapers, trade publications, magazines, fliers, handouts and the like.

It will thus be seen according to the present invention a highly advantageous messaging substrate suitable for marketing advertising and the creation of commemorative pieces has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. An elongated advertising substrate, comprising;
a substrate having first and second faces, and first and second ends each of said first and second faces having a surface;
said first face having a first area defined by an area between said first end and a first slit for receiving indicia relating to a first part of an advertising message and said second face having a second area defined by an area between said second end and a second slit for receiving indicia relating to a second part of an advertising message, one of said first and second parts comprising a substantial portion of said message; and
wherein each of said first and second areas having at least one cut or slit, with at least one of the cuts of said areas being close to said ends than a mid point such that when said substrate is wrapped about an article, said first and second parts of said advertising message cooperate to form a single advertising message.

2. An elongated advertising message substrate as recited in claim 1, wherein said substrate may be used for communicating messages and selected from a group including product or service promotions, advertisements in retail locations, wholesale stores, franchise operations, merchandising outlets, religious messages, welcoming or greeting memorandums, redemption pieces, coupons and combinations thereof.

3. An elongated advertising message substrate as recited in claim 1, wherein said substrate is used for a commemorative communication from a group including notices, announcements, ceremonies, graduations, weddings, anniversaries, promotions, competitive wins, political victories, promotional, religious or scriptural publications and combinations thereof.

4. An elongated advertising messaging substrate as recited in claim 1, wherein said messaging substrate is suitable for use with articles selected from a group including bottles, utensils, flower bundles and combinations thereof.

5. A message communication device, comprising;
an article having a substantially cylindrical portion;
a substrate having first and second faces, and first and second ends each of said first and second faces having a surface; said first face having a first area for receiving indicia relating to a first part of an advertising message and said second face having a second area for receiving indicia relating to a second part of an advertising message, one of said first and second parts comprising a substantial portion of said message and said substrate, each of said first and second areas having at least one cut or slit, with the cut of at least one of said areas being adjacent one of said ends, such that when said substrate is wrapped about an article, said first and second parts of said advertising message cooperate to form a single advertising message; and
wherein said substrate is wrapped about said cylindrical portion of said article, to create an advertising message.

6. A messaging communication device, comprising;
a substrate having first and second faces and at least a first indicia, printed on at least a portion of one of said first and second faces of said substrate; said substrate having at least second indicia, distinct from said first indicia printed on a second portion of said first and second faces of said substrate; said substrate having at least third indicia distinct from each of said first and second indicia printed on at least a third portion of said first and second faces of given substrate; and wherein said first and third indicia cooperate to form a message.

7. A messaging communication device as recited in claim 6 wherein said substrate having first and second faces and at least a first indicia, contains at least one slit extending at least part way through the substrate.

8. A method of marketing a business form communication collateral device, comprising the steps of;
assembling data relating to business service;
preparing a layout for said service;
obtaining a business form having at least a first part, said first part having first and second faces;
printing at least a first marketing communication message on one of said first and second faces using said layout;
printing at least a second marketing communication message on one of said first and second faces using said layout;
distributing said marketing communication collateral; and
displaying collateral in connection with an article.

9. A method as recited in claim 8 wherein said service is related to printed business products used in marketing, business, personal communications, and combinations thereof.

10. A method as recited in claim 8 wherein said step of preparing said layout may include numerical, pictorial, other graphical related messages, and combinations thereof, to provide a retail marketing message.

11. A method as recited in claim 8 wherein said method includes a further step of adding complementary unprinted or printed communication messaging material prior to the step of distributing.

12. A method as recited in claim 8 wherein said method includes displaying communication collateral in connection with an article.
